(19) United States
(12) Patent Application Publication
(10) Pub. No.: US 2016/0124533 A1
(43) Pub. Date: May 5, 2016

(54) METHOD AND SYSTEM FOR MOBILE DEVICE TRANSITION TO ALTERNATE INTERFACE MODE OF OPERATION

(71) Applicant: Kobo Incorporated, Toronto (CA)

(72) Inventor: Benjamin LANDAU, Toronto (CA)

(21) Appl. No.: 14/528,625

(22) Filed: Oct. 30, 2014

(51) Int. Cl. G06F 3/041; G06F 3/01

(52) U.S. Cl. CPC G06F 3/041; G06F 3/017

(57) ABSTRACT

A computing device, or electronic personal display, includes a housing and a display screen. The housing at least partially circumvents the screen so that the screen is viewable and a set of touch sensors are provided therewith. A processor is provided within the housing to detect a gesture via the set of touch sensors, interpret the gesture as one of a plurality of user inputs, and accomplish an output operation of the computing device. The processor, upon detecting a presence of extraneous objects on a surface the screen of the display assembly, associates the output operation for performance in consequence to a motion input.

### TECHNICAL FIELD

Examples described herein relate to a system and method for transitioning a mobile computing device to operation in an alternate interface mode.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like).

Some electronic personal display devices are purpose built devices designed to perform especially well at displaying digitally-stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

There are also numerous kinds of consumer devices that can receive services and resources from a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device for transitioning to an alternate mode of operation, according to an embodiment.

FIG. 2 illustrates an example architecture of a computing device for transitioning to an alternate mode of operation, according to an embodiment.

FIG. 3 illustrates a method of operating a computing device for transitioning to an alternate mode of operation, according to an embodiment.

### DETAILED DESCRIPTION

Embodiments described herein provide for a computing device that is operable even when water and/or other persistent objects are present on the surface of a display of the computing device. More specifically, the computing device may detect a presence of extraneous objects (e.g., such as water, dirt, or debris) on a surface of the display screen, and perform one or more operations to mitigate or overcome the presence of such extraneous objects in order to maintain a functionality fur use as intended, and/or viewability of content displayed on the display screen. For example, upon detecting the presence of one or more extraneous objects, such as water droplets, debris or dirt, certain settings or configurations of the computing device may be automatically adjusted, thereby invoking operation via an alternate user interface mode, whereby gestures may be dissociated from recognition as valid user input commands to perform a given processor output operation, and instead, an alternate user input scheme becomes associated with performance of said processor output operation.

“E-books” are a form of electronic publication content stored in digital format in a computer non-transitory memory, viewable on a computing device with suitable functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content fur viewing, such as via discrete successive pages.

An “e-reading device”, also referred to herein as an electronic personal display, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultramobile computing device, or a wearable computing device with a form factor of a wearable accessory device (e.g., smart watch or bracelet, glasswear integrated with a computing device, etc.). As another example, an e-reading device can include an e-reader device, such as a purpose-built device that is optimized for an e-reading experience (e.g., with E-ink displays).

One or more embodiments described herein provide that methods, techniques and actions performed by a computing device are performed programmatically, or as a computer-implemented method. Programmatically means through the use of code or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

### System and Hardware Description

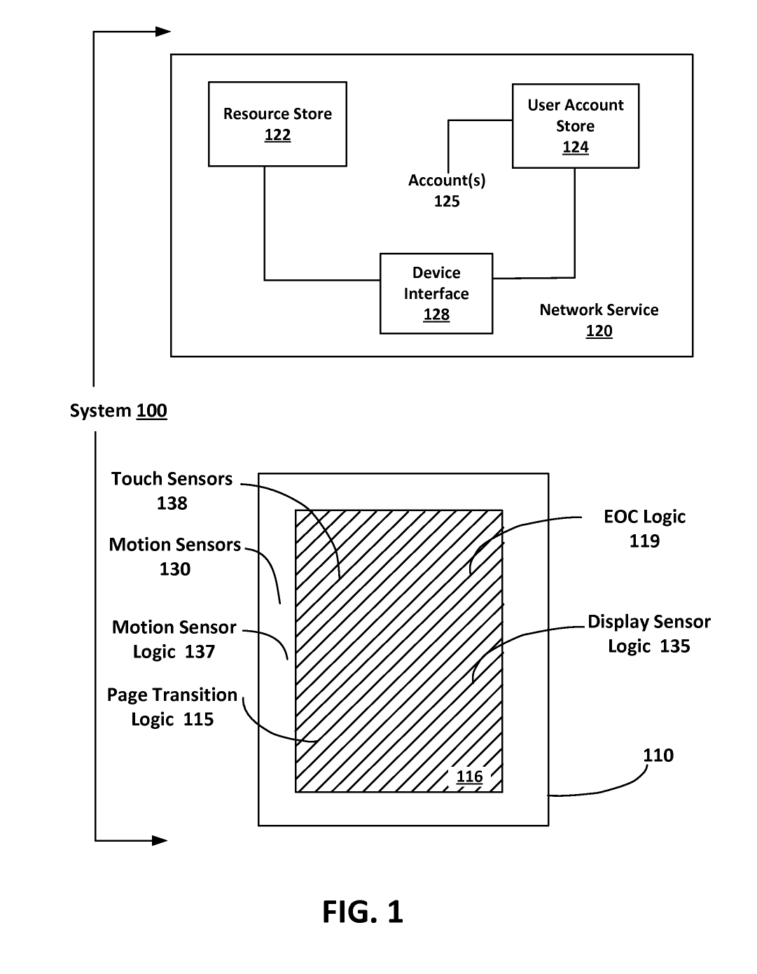

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services which communicate with the e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 120 and enables e-books provided through the service to be viewed and consumed. In another implementation, the e-reading device 110 can run a media playback or streaming application that receives tiles or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user.

As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display screen 116 and a housing 118. In an embodiment, the display screen 116 is touch-sensitive, to process touch inputs including gestures (e.g., swipes). For example, the display screen 116 may be integrated with one or more touch sensors 138 to provide a touch sensing region on a surface of the display screen 116. For some embodiments, the one or more touch sensors 138 may include capacitive sensors that can sense or detect a human body's capacitance as input. In the example of FIG. 1, the touch sensing region coincides with a substantial surface area, if not all, of the display screen 116. Additionally, the housing 118 can also be integrated with touch sensors to provide one or more touch sensing regions, for example, on the bezel and/or back surface of the housing 118.

In some embodiments, the e-reading device 110 includes features for providing functionality related to displaying paginated content. The e-reading device 110 can include page transitioning logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch sensing region of the display screen 116. For example, the user may swipe the surface of the display screen 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display screen 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display screen 116.

E-reading device 110 can also include one or more motion sensors 136 arranged to detect motion imparted thereto, such as by a user while reading or in accessing associated functionality. In general, the motion sensor(s) 136 may be selected from one or more of a number of motion recognition sensors, such as but not limited to, an accelerometer, a magnetometer, a gyroscope and a camera. Further still, motion sensor 136 may incorporate or apply some combination of the latter motion recognition sensors,

In an accelerometer-based embodiment of motion sensor 135, when an accelerometer experiences acceleration, a mass is displaced to the point that a spring is able to accelerate the mass at the same rate as the casing. The displacement is then measured thereby determining the acceleration. In one embodiment, piezoelectric, piezoresistive and capacitive components are used to convert the mechanical motion into an electrical signal. For example, piezoelectric accelerometers are useful for upper frequency and high temperature ranges. In contrast, piezoresistive accelerometers are valuable in higher shock applications. Capacitive accelerometers use a silicon micro-machined sensing element and perform well in low frequency ranges. In another embodiment, the accelerometer may be a micro electro-mechanical systems (MEMS) consisting of a cantilever beam with a seismic mass.

In an alternate embodiment of motion sensor 136, a magnetometer, such as a magnetoresistive permalloy sensor can be used as a compass. For example, using a three-axis magnetometer allows a detection of a change in direction regardless of the way the device is oriented. That is, the three-axis magnetometer is not sensitive to the way it is oriented as it will provide a compass type heading regardless of the device's orientation.

In another embodiment of motion sensor 136, a gyroscope measures or maintains orientation based on the principles of angular momentum. In one embodiment, the combination of a gyroscope and an accelerometer comprising motion sensor 135 provides more robust direction and motion sensing.

In yet another embodiment of motion sensor 136, a camera can be used to provide egomotion, e.g., recognition of the 3D motion of the camera based on changes in the images captured by the camera. In one embodiment, the process of estimating a camera's motion within an environment involves the use of visual odometry techniques on a sequence of images captured by the moving camera. In one embodiment, it is done using feature detection to construct an optical flow from two image frames in a sequence. For example, features are detected in the first frame, and then matched in the second frame. The information is then used to make the optical flow field showing features diverging from a single point, e.g., the focus of expansion. The focus of expansion indicates the direction of the motion of the camera. Other methods of extracting egomotion information from images, method that avoid feature detection and optical flow fields are also contemplated. Such methods include using the image intensities for comparison and the like.

According to some embodiments, the e-reading device 110 includes display sensor logic 135 to detect and interpret user input or user input commands made through interaction with the touch sensors 138. By way of example, the display sensor logic 135 can detect a user making contact with the touch sensing region of the display screen 116. More specifically, the display sensor logic 135 can detect taps, an initial tap held in sustained contact or proximity with display screen 116 (otherwise known as a “long press”), multiple taps, and/or swiping gesture actions made through user interaction with the touch sensing region of the display screen 116. Furthermore, the display sensor logic 135 can interpret such interactions in a variety of ways. For example, each interaction may be interpreted as a particular type of user input corresponding with a change in state of the display 116.

For some embodiments, the display sensor logic 135 may further detect the presence of water, dirt, debris, and/or other extraneous objects on the surface of the display 116. For example, the display sensor logic 135 may be integrated with a water-sensitive switch (e.g., such as an optical rain sensor) to detect an accumulation of water on the surface of the display 116. In a particular embodiment, the display sensor logic 135 may interpret simultaneous contact with multiple touch sensors 138 as a type of non-user input. For example, the multi-sensor contact may be provided, in part, by water and/or other unwanted or extraneous objects (e.g., dirt, debris, etc.) interacting with the touch sensors 138. Specifically, the e-reading device 110 may then determine, based on the multi-sensor contact, that at least a portion of the multi-sensor contact is attributable to presence of water and/or other extraneous objects on the surface of the display 116.

E-reading device 110 further includes motion gesture logic 137 to interpret user input motions as commands based on detection of the input motions by motion sensor(s) 136. For example, input motions performed on e-reading device 110 such as a tilt, a shake, a rotation, a swivel or partial rotation and an inversion may be detected via motion sensors 136 and interpreted as respective commands by motion gesture logic 137.

E-reading device 110 further includes extraneous object configuration (EOC) logic 119 to adjust one or more settings of the e-reading device 110 to account for the presence of water and/or other extraneous objects being in contact with the display screen 116. For example, upon detecting the presence of water and/or other extraneous objects on the surface of the display screen 116, the EOC logic 119 may power of the e-reading device 110 to prevent malfunctioning and/or damage to the device 110. EOC logic 119 may then reconfigure the e-reading device 110 by invalidating or dissociating a touch screen gesture from being interpreted as a valid input command, and in lieu thereof, associate an alternative type of user interactions as valid input commands, e.g., motion inputs that are detected via the motion sensor(s) 136 will now be associated with any given input command previously enacted via the touch sensors 138 and display sensor logic 135. This enables a user to continue operating the e-reading device 110 even with the water and/or other extraneous objects present on the surface of the display screen 116, albeit by using the alternate type of user interaction.

In some embodiments, input motions performed on e-reading device 110, including but not limited to a tilt, a shake, a rotation, a swivel or partial rotation and an inversion may be detected via motion sensors 136 and interpreted by motion gesture logic 137 to accomplish respective output operations for e-reading actions, such as turning a page (whether advancing or backwards), placing a bookmark on a given page or page portion, placing the e-reader device in a sleep state, a power-on state or a power-off state, and navigating from the e-book being read to access and display an e-library collection of e-books that may be associated with user account store 124.

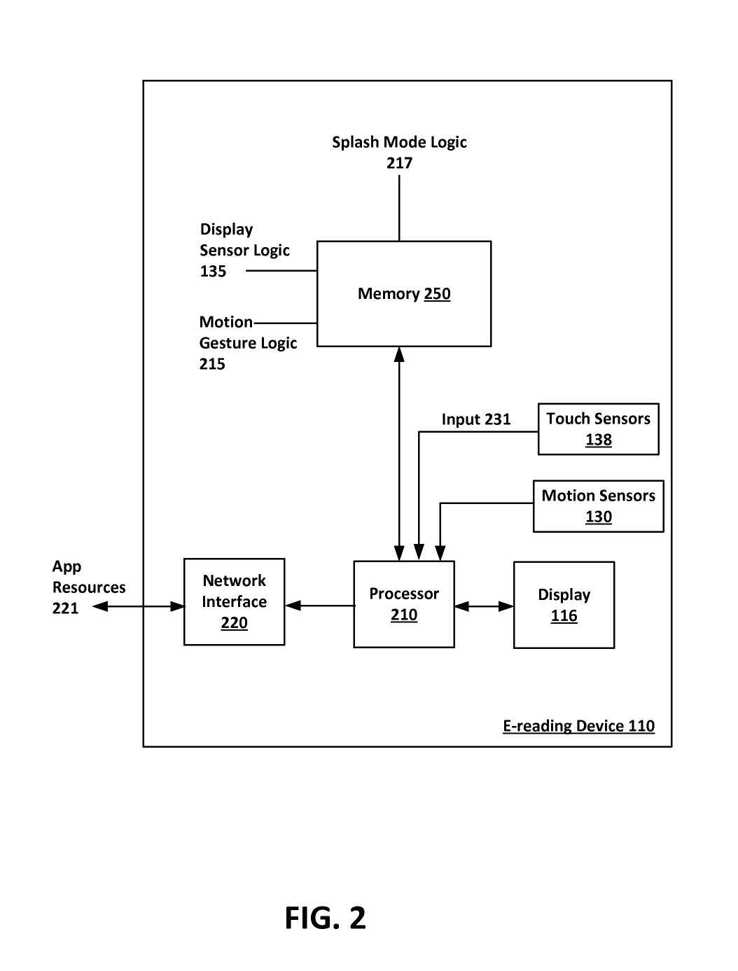

FIG. 2 illustrates an architecture, in one embodiment, of e-reading device 110 as described above with respect to FIG. 1. With reference to FIG. 2, e-reading device 110 further includes a processor 210, a memory 250 storing instructions and logic pertaining at least to display sensor logic 135, extraneous object logic 119 and motion gesture logic 137.

The processor 210 can implement functionality using the logic and instructions stored in the memory 250. Additionally, in some implementations, the processor 210 utilizes the network interface 220 to communicate with the network service 120 (see FIG. 1). More specifically, the e-reading device 110 can access the network service 120 to receive various kinds of resources (e.g., digital content items such as e-books, configuration files, account information), as well as to provide information (e.g., user account information, service requests etc.). For example, e-reading device 110 can receive application resources 221, such as e-books or media files, that the user elects to purchase or otherwise download via the network service 120. The application resources 221 that are downloaded onto the e-reading device 110 can be stored in the memory 250.

In some implementations, the display 118 can correspond to, for example, a liquid crystal display (LCD) or light emitting diode (LED) display that illuminates in order to provide content generated from processor 210. In some implementations, the display 116 can be touch-sensitive. For example, in some embodiments, one or more of the touch sensor components 138 may be integrated with the display 116. In other embodiments, the touch sensor components 138 may be provided (e.g., as a layer) above or below the display 116 such that individual touch sensor components 116 track different regions of the display 116. Further, in some variations, the display 116 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the touch sensor components 138, the display 116, and/or other input mechanisms (e.g., buttons, keyboard, mouse, microphone, etc.). With reference to examples described herein, the processor 210 can respond to input 231 detected at the touch sensor components 138. In some embodiments, the processor 210 responds to inputs 231 from the touch sensor components 138 in order to facilitate or enhance e-book activities such as generating e-book content on the display 116, performing page transitions of the displayed e-book content, powering off the device 110 and/or display 116, activating a screen saver, launching or closing an application, and/or otherwise altering a state of the display 116.

In some embodiments, the memory 250 may store display sensor logic 135 that monitors for user interactions detected through the touch sensor components 138, and further processes the user interactions as a particular input or type of input. In an alternative embodiment, the display sensor logic 135 may be integrated with the touch sensor components 138. For example, the touch sensor components 138 can be provided as a modular component that includes integrated circuits or other hardware logic, and such resources can provide some or all of the display sensor logic 135. In variations, some or all of the display sensor logic 135 may be implemented with the processor 210 (which utilizes instructions stored in the memory 250), or with an alternative processing resource.

For some embodiments, the display sensor logic 135 may detect the presence of water and/or other extraneous objects, including debris and dirt, on the surface of the display 116. For example, the display sensor logic 135 may determine that extraneous objects are present on the surface of the display 116 based on a number of touch-based interactions detected via the touch sensors 138 and/or a contact duration (e.g., a length of time for which contact is maintained with a corresponding touch sensor 138) associated with each interaction. More specifically, the display sensor logic 135 may detect the presence of water and/or other extraneous objects if a detected interaction falls outside a set of known gestures (e.g., gestures that are recognized by the e-reading device 110). Such embodiments are discussed in greater detail, for example, in co-pending U.S. patent application Ser. No. 14/498,661, titled “Method and System for Sensing Water, Debris or Other Extraneous Objects on a Display Screen,” filed Sep. 26, 2014, which is hereby incorporated by reference in its entirety.

In one implementation, the display sensor logic 135 includes detection logic 213 and gesture logic 215. The detection logic 213 implements operations to monitor for the user contacting a surface of the display 116 coinciding with a placement of one or more touch sensor components 138. The gesture logic 215 detects and correlates a particular gesture (e.g., pinching, swiping, tapping, etc.) as a particular type of input or user action. The gesture logic 215 may also detect directionality so as to distinguish between, for example, leftward or rightward swipes.

For some embodiments, the display sensor logic 135 further includes splash mode (SM) logic 217 for adjusting one or more settings of the e-reading device 110 in response to detecting the presence of water and/or other extraneous objects on the surface of the display 116. For example, the splash mode logic 217 may configure thee-reading device 110 to operate in a “splash mode” when water and/or other extraneous objects are present (e.g., “splashed”) on the surface of the display 116. While operating in splash mode, one or more device configurations may be altered or reconfigured to enable the e-reading device 110 to be continuously operable even while water and/or other extraneous objects are present on the surface of the display 116. More specifically, the splash mode logic 217 may perform one or more operations to mitigate or overcome the presence of extraneous objects (e.g., such as water) on the surface of the display 116. Accordingly, the splash mode logic 217 may be activated by the display sensor logic 135 upon detecting the presence of extraneous objects on the surface of the display 116.

For some embodiments, the splash mode logic 217 may reconfigure one or more actions (e.g., input responses) that are to be performed by the e-reading device 110 in response to user inputs. For example, the splash mode logic 217 may disable or dissociate certain actions (e.g., such as performing multi-page and/or chapter transitions) that are triggered by user touch interactions (e.g., requiring concurrent contact at multiple distinct locations on the display 116) and/or persistent user interactions (e.g., requiring continuous contact with the touch sensors 138 over a given duration) because such interactions could be misinterpreted by the gesture logic 215 given the presence of extraneous objects on the surface of the display 116. The disabling or dissociation may be accomplished by terminating electrical power selectively to those components implicated in a portion of circuitry, using interrupt-based logic to selectively disable the components involved, such as touch sensors 138 disposed in association with display screen 116.

Additionally, and/or alternatively, the splash mode logic 217 may enable a new set of actions to be performed by the e-reading device 110. For example, the splash mode logic 217 may remap, or associate, one or more user input commands to a new set of motion actions as detected by motion sensor(s) 136. With motion sensor(s) activated for use in conjunction with splash mode 217, a new set of actions (e.g., such as a tilt, a shake, a rotation, a swivel or partial rotation and an inversion of e-reading device 110 as detected via motion sensors 136 for interpretation as respective input commands by motion gesture logic 137) may be performed on the e-reading device 110 and be validated or recognized only when water and/or other extraneous objects are present on the surface of the display 116. More specifically, the new set of actions may enable the e-reading device 110 to operate in an optimized manner while the water and/or other extraneous objects are present.

### Methodology

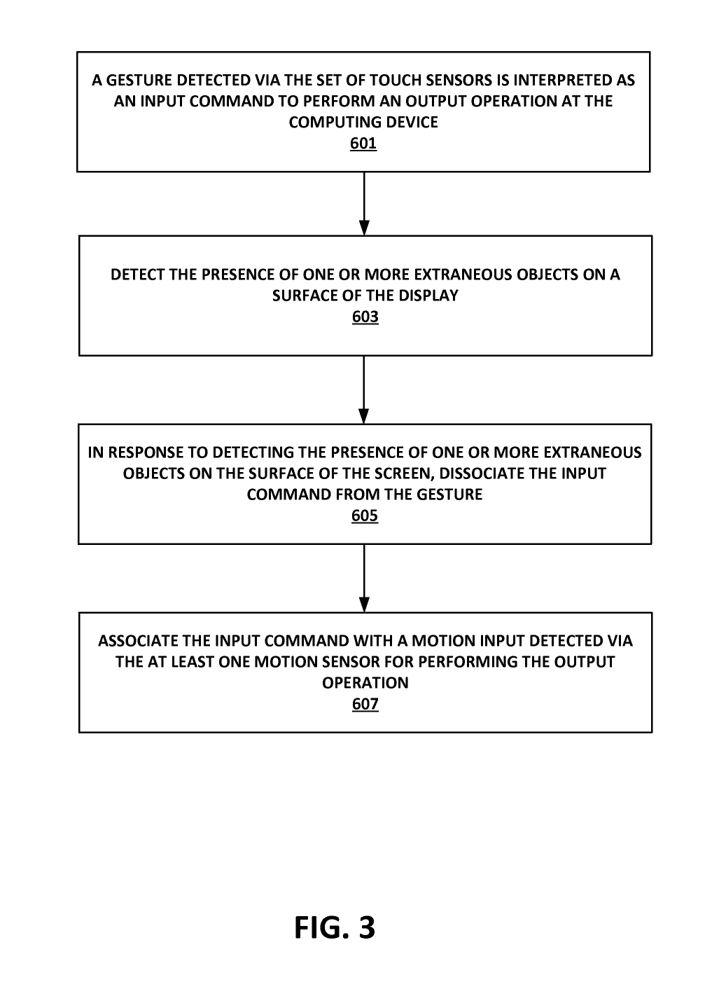

FIG. 3 illustrates a method of operating an e-reading device 110 when water and/or other extraneous objects are present on the display 116, according to one or more embodiments. In describing the example of FIG. 3, reference may be made to components such as described with FIGS. 1 and 2 for purposes of illustrating suitable components and logic modules for performing a step or sub-step being described.

With reference to the example of FIG. 3, at step 301 the e-reading device 110 may detect the presence of one or more extraneous objects on a surface of the display 116 (610). For some embodiments, the display sensor logic 135 may detect the presence of extraneous objects on the surface of the display 116 based on a number of touch-based interactions detected via the touch sensors 138 and/or a contact duration associated with each of the interactions. For example, the display sensor logic 135 may determine that extraneous objects are present on the surface of the display 116 if a detected interaction falls outside a set of known gestures.

At step 301, a gesture detected via the set of touch sensors is interpreted as an input command to perform an output operation at the computing device 110.

At step 303, splash mode logic 217 detects the presence of one or more extraneous objects on a surface of the display 116.

At step 305, the splash mode logic 217 may disable or dissociate certain user input commands associated with touch gestures such as a tap, a sustained touch, a swipe or some combination thereof, received at display screen 116 as detected via touch sensors 138.

At step 307, splash mode logic 217 in conjunction with motion gesture logic 137 then reconfigures or remaps the set of user input commands by associating ones of the set with respective motion input commands as detected via motion sensors 136. Example motions may include a tilt, a shake, a rotation, a swivel or partial rotation an inversion, or some combination thereof, of e-reading device 110 as detected via motion sensors 136 and interpreted by motion gesture logic 137 to accomplish respective output operations for e-reading actions, such as turning a page (whether advancing or backwards), placing a bookmark on a given page or page portion, placing the e-reader device in a sleep state, a power-on state or a power-off state, and navigating from the e-book being read to access and display an e-library collection of e-books that may be associated with user account store 124.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A computing device comprising:
a display screen;
a housing that at least partially circumvents the display screen;
a set of touch sensors;
at least one motion sensor; and
a processor provided within the housing that detects a presence of one or more extraneous objects on a surface of the screen, the processor further operable to:
detect a gesture via the set of touch sensors;
interpret the gesture as an input command to perform an output operation at he computing device;
in response to detecting the presence of one or more extraneous objects on the surface of the screen, dissociate the input command from the gesture; and
associate the input command with a motion input detected via the at least one motion sensor for performing the output operation.

2. The computing device of claim 1, wherein the gesture detected via the touch sensors consists of one of: a tap, a sustained touch, and a swipe.

3. The computing device of claim 1, wherein the motion sensor is one of: an accelerometer, a gyroscope, a magnetometer and a camera.

4. The computing device of claim 1, wherein the output operation comprises a page turn.

5. The computing device of claim 1, wherein the output operation comprises a bookmark.

6. The computing device of claim 1, wherein the output operation is one of a power-on state change and a power-off state change.

7. The computing device of claim 1, wherein the output operation comprises a return to e-library collection.

8. The computing device of claim 1, wherein the motion input is one of a tilt, a shake, a flick, a rotation, a partial rotation and an inversion.

9. A method for operating a computing device, the method implemented in a processor and comprising:
detecting a gesture via a set of touch sensors provided with a display screen of the electronic personal display;
interpreting the gesture as an input command to perform an output operation at the computing device;
in response to detecting the presence of one or more extraneous objects on the surface of the screen, dissociating the input command from the gesture; and
associating the input command with a motion input detected via at least one motion sensor provided at the computing device for performing the output operation.

10. The method of claim 9, wherein the gesture detected via the set of touch sensors is one of: a tap, a sustained touch, and a swipe.

11. The method of claim 9, wherein the motion sensor is one of: an accelerometer, a gyroscope, a magnetometer and a camera.

12. The method of claim 9, wherein the output operation comprises a page turn.

13. The method of claim 9, wherein the output operation comprises a bookmark.

14. The method of claim 9, wherein the output operation is one of a power-on state change and a power-off state change.

15. The method of claim 9, wherein the output operation comprises a return to e-library collection input.

16. The method of claim 9 wherein the motion input is one of: a tilt, a shake, a flick, a rotation, a partial rotation and an inversion.

17. A non-transitory computer-readable medium storing instructions that, when executed by a processor of a computing device, cause the processor to perform operations that include:
detecting a gesture via a set of touch sensors provided with a display screen of the electronic personal display;
interpreting the gesture as an input command to perform an output operation at the computing device;
in response to detecting the presence of one or more extraneous objects on the surface of the screen, dissociating the input command from the gesture; and
associating the input command with a motion input detected via at least one motion sensor provided at the computing device for performing the output operation.
